(19) United States
(12) Patent Application Publication
(10) Pub. No.: US 2007/0098966 A1
(43) Pub. Date: May 3, 2007

(54) Patterned transfer of metallic elements using photo-degradable polymer templates

(76) Inventor: Zhang-Lin Zhou, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,807

(22) Filed: Oct. 28, 2005

(51) Int. Cl. B32B 3/00

(52) U.S. Cl. 428/209

(57) ABSTRACT

The present invention is drawn to a method of printing metallic elements, comprising steps of forming a photo-degradable polymer template comprising a photo-degradable polymer, depositing a metal layer on the template, and adhering at least a portion of the metal layer to a substrate. Additional steps include exposing the template to photo energy to cause the photo-degradable polymer to degrade, and leaving at least a portion of the metal layer adhered to the substrate to form printed metallic elements.

### FIELD OF THE INVENTION

The present invention relates generally to printing of metallic elements. More particularly, the present invention relates to patterned transfer of metallic nano-structures to substrates using photo-degradable polymers.

### BACKGROUND OF THE INVENTION

Formation of electronic components, high resolution nano-devices, and other devices including conductive paths at molecular scales can be accomplished using a wide variety of methods. Examples of such devices include electronic devices, data storage devices, and displays, as well as devices to be used in emerging applications in microfluidics, optoelectronics, plastic electronics, and biological or chemical sensors. Typical methods for manufacturing can be by printing processes including ink-jet printing of circuits, print and etch methods, screen printing methods, and photoresist methods. Other current methods are focused on printing process other than standard photolithography to lower the costs of nano-fabrication and to increase the range of patterning applications. Frequently, these methods involve considerable capital cost and production time, and many are not practical for use to form nano-devices or devices including nano-circuitry.

Specifically, with respect to soft lithography, this method relies on a reusable template, generally poly(dimethylsiloxane) (PDMS), to transfer patterned materials directly from the template to the substrate. A major problem in this type of printing arises from the fact that interfacial forces between the template and the device to be removed therefrom can be great, thus making it difficult to transfer/separate the template from the formed device or material to be deposited. To overcome this problem in soft lithography, the properties and processing requirements for the soft lithography template typically utilize a stable release layer or liner which allows for template separation while maintaining the integrity of the device or material being removed therefrom in the printing process. This release liner can limit the resolution of the printed material, and further, can limit the materials choice, e.g., the substrate, release liner, and printing composition must be compatible.

For this and other reasons, the need still exists for improved methods of nano-printing which can be carried out at decreased manufacturing costs, allow for a wider variety of printing composition and substrate combinations, and which can provide high resolution printing at a nano-scale level.

### SUMMARY OF THE INVENTION

It has been recognized that it would be advantageous to develop methods of printing metallic elements. Such methods can include steps of forming a photo-degradable polymer template comprising a photo-degradable polymer, depositing a metal layer on the photo-degradable polymer template, and adhering at least a portion of the metal layer to a substrate. Further steps can include exposing the photo-degradable polymer template to photo energy to cause the photo-degradable polymer to degrade, and leaving at least a portion of the metal layer adhered to the substrate to form printed metallic elements.

Additional features and advantages of the invention will be apparent from the following detailed description, which illustrates, by way of example, features of the invention.

### DETAILED DESCRIPTION OF THE PREFERRED EMBODIMENT(S)

Reference will now be made to exemplary embodiments and specific language will be used herein to describe the same. It will nevertheless be understood that no limitation of the scope of the invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a metal” includes reference to one or more of such materials.

The term “photo-degradable” when referring to polymers includes any polymer that can be broken down or otherwise degraded by photo energy, such as UV radiation, IR radiation, visible-light radiation, etc. For example, a UV-degradable polymer is one type of photo-degradable polymer.

The term “template” is used in two contexts. Master pattern templates refer to template-type structures that are used to form the photo-degradable polymer templates of the present invention. In other words, the master pattern template is not a printing template per se, but is used to form the template that acts as the “printing” template, i.e., the photo-degradable polymer template.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 μm to about 200 μm should be interpreted to include not only the explicitly recited limits of 1 μm and about 200 μm, but also to include individual sizes such as 2 μm, 3 μm, 4 μm, and sub-ranges such as 10 μm to 50 μm, 20 μm to 100 μm, etc.

In accordance with the present invention, a new type of printing process that uses a photo-degradable polymer template for patterned transfer has been developed. In the prior art, typically, polydimethylsiloxane (PDMS) stamps have been used as a template to apply metals in this type of printing. This method has the drawback of being difficult to remove the template from the metal once the metal is printed or stamped onto a desired substrate. In accordance with the present invention, by using a photo-degradable polymer template as the printing template, the polymer template decomposes upon photo radiation after or at the same time as template/substrate coupling, thus eliminating the potential complications associated with physical release and template reuse, while providing several advantages including higher resolution, improved application range, and better alignment.

With this in mind, in accordance with embodiments of the present invention, a method of printing metallic elements can comprise forming a photo-degradable polymer template comprising a photo-degradable polymer, depositing a metal layer on the photo-degradable polymer template, and adhering at least a portion of the metal layer to a substrate. Further steps can include exposing the photo-degradable polymer template to photo energy to cause the photo-degradable polymer to degrade, and leaving at least a portion of the metal layer adhered to the substrate to form printed metallic elements.

In another embodiment, a substrate printed with metallic elements can comprise a substrate and metallic elements printed on the substrate. The metallic elements can be printed by the steps forming a photo-degradable polymer template comprising a photo-degradable polymer, depositing a metal layer on the photo-degradable polymer template, and adhering at least a portion of the metal layer to the substrate. Additional steps can include exposing the photo-degradable polymer template to photo energy to cause the photo-degradable polymer to degrade, and leaving at least a portion of the metal layer adhered to the substrate to form printed metallic elements.

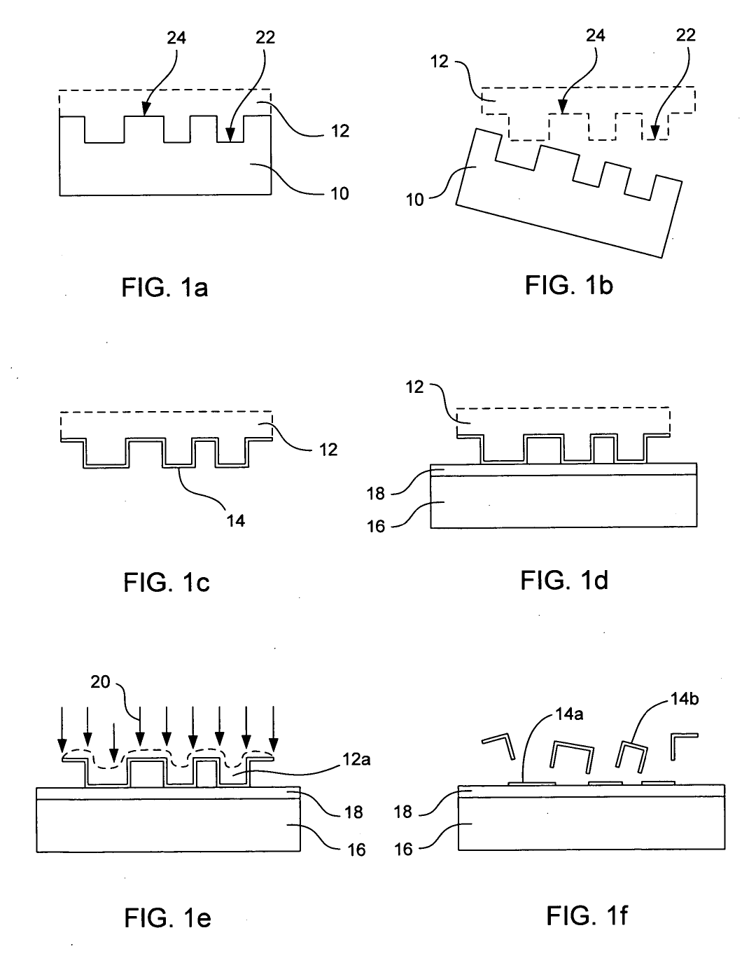

In further detail, FIGS. 1a to 1f schematically depict an exemplary process in accordance with embodiments of the present invention. As shown in FIGS. 1a and 1b, the process involves the replication of prefabricated surface patterns in the form of a photo-degradable polymer template 12, which includes peaks 22 and troughs 24. A master pattern template 10 is used to form the photo-degradable polymer template. The master pattern template is essentially of a three-dimensional negative of the photo-degradable polymer template to be formed. These master pattern templates or molds can be prepared by standard etching processes, deep reactive ion etching, isotropic plasma etching, SU-8 photolithography, or other known methods. Materials that can be used are generally known in the art, and can include silicon wafers, silicon oxide polymers such as polydimethylsiloxane (PDMS), poly-lactic-co-glycolic acid (PLGA), polydibutylsiloxane, for example. As mentioned, in this embodiment, the master pattern template is used as a mold to form the photo-degradable polymer template, which can be prepared by spin-casting a photo-degradable polymer film-forming solution onto the surface of the master pattern template. Alternatively, mixing of monomers can be carried out at the master pattern site as well. Once cast or mixed at the site, the solution undergoes solidification upon evaporation of the casting solvents at room temperature (or upon application of heat), and a thin film is formed. Thickness can be varied by modifying conditions such as rotation speed, time, and ambient environment. Resolution can be achieved by exploiting the ability of spin-casting to fill the voids and recess of the master surface template.

Once formed, the photo-degradable polymer template 12 is removed from the master pattern template 10, as shown in FIG. 1b. This can be carried out by binding a preformed solid polymer sheet (not shown) to an outer surface of the photo-degradable polymer template by rolling the sheet on the surface of the template, thus detaching the photo-degradable polymer template from the master pattern template by peeling. With respect to the types of photo-degradable polymers that can be used, any photo-degradable polymer that is functional for a given application is within the scope of the present invention, and more detailed description of certain specific photo-degradable polymers will be discussed in more detail below.

As shown in FIG. 1c, after the fabrication and detachment of the photo-degradable polymer template 12, a metallic thin film or metal layer 14 can be deposited on the surface of the photo-degradable polymer template. This can be carried out by a sputtering process, or by chemical vapor deposition (CVD), for example. A wide variety of patterns can be replicated on the photo-degradable polymer template. Various metals can be used, and include metal oxides or hydroxides, elemental metals, metal alloys, and/or metal salts. Specific exemplary metals that can be used include gold, silver, copper, platinum, aluminum, zinc, cadmium, cobalt, nickel, palladium, iridium, iron, lead.

As shown in FIG. 1d, once the metallic thin film or metal layer is formed on the photo-degradable polymer template, the metallic thin film can be contacted and adhered to a substrate 16. The metallic thin film can be adhered to the substrate by any of a number of methods, including chemical or physical bonding techniques utilizing an intervening adhesive layer 18, or by directing bonding of the patterned thin film to the substrate in the absence of an intervening an intervening adhesive layer.

Suitable substrates 16 can include ceramics, polymers, cellulose, glass, silicon, organic substrates, metal oxides, phenolic materials, wafer boards, epoxy glasses, electrically compatible plastics, and combinations or composites thereof. Examples of several specific substrates include standard silicon substrates, polyethylene terephthalates (available from E. I. du Pont de Nemours and Company as MYLAR), polyimides (available from E. I. du Pont de Nemours and Company as KAPTON), epoxy resins, phenolic resins, polyester resins, aluminum nitride, and alumina ceramics. Although the above mentioned substrates are suitable, almost any non-conductive or semi-conductive material or flexible or non-flexible material can be used as the substrate in the present invention. Often, dielectric materials can be preferred for use. In addition, the methods of the present invention can be applied to substrates having previously formed electronic circuits and/or devices thereon.

Suitable adhesive layers 18 that can be applied to the substrate 16 include coatings reactive with surface hydroxyls that are often inherently present on the surface of many metals. Other coatings that would be is chemically reactive with the metal layer include organopolysiloxane elastomers (silicone rubbers), epoxy resins, cyanoacrylate adhesives, acrylic adhesives, methacrylate adhesives, or the like. Alternatively, the adhesive layer can be of a material that merely physically bonds the metal layer to the substrate, including glues and other known tacky materials.

After the metallic thin film or metal layer 14 has been bonded to a surface of the substrate 16 or adhesive layer 18, the photo-degradable polymer template can then be decomposed or degraded using photo energy 20, as shown in FIG. 1e. Again, the type of photo energy selected for use should be of an appropriate wavelength and power level, as is known in the art, to substantially degrade the photo-degradable polymer used to form the template, as shown at 12a. Once sufficiently degraded, a first portion of the metallic thin film 14a that is bonded to the substrate (or the adhesive layer) will remain substantially intact, while a second portion of metallic thin film 14b that is not bonded to the substrate (or adhesive layer) will break off and be removed. The resulting structure is a substrate having metallic elements printed thereon.

In accordance with the figures and other related embodiments, a new class of printing that utilizes a photo-degradable polymer template for pattern transfer provides advantages over other lithography processes. As mentioned, because the polymer template decomposes upon irradiation from UV or other light energy after template/substrate coupling, the potential complications associated with physical release and template reuse are removed. At the same time, several advantages are realized including improved resolution, application range, and alignment. Further, the printing strategies that employ photo-degradable polymer templates provide a practical approach for high resolution nano-fabrication. For example, this process can utilize standard tooling; the chemicals for use are readily available, low-cost, nontoxic, nontoxic, biocompatible, and simple to apply and store; and can also be carried out without the need for clean room conditions.

The metallic elements printed or prepared in accordance with embodiments of the present invention can be useful for a number of applications, including for preparing conductive paths for electronic circuitry, and in research and commercial development of nano-fabricated device technologies at molecular scales. To illustrate, these devices produced in accordance with the principles of the present invention can form a wide variety of electronic devices, and the resolution and complexity of such devices are only limited by the printing technique chosen for application of the printable composition. Conductive paths that can be prepared in accordance with the present invention can include, for example, complex circuit, single traces, antennas, multilayered circuits, transistors, resistors, inductors, gates, diodes, capacitors, magnets, and combinations thereof. Alternatively, the printing of metallic elements can be used to form a conductive pattern that can be formed as an aesthetic, decorational, or informational design. In both functional and aesthetic applications, devices can be formed having conductive elements within the order of nano-scale devices or circuits, and even at scales approaching the molecular scale.

Metallic elements formed using the printable composition of the present invention can have a line width of from about 0.01 μm up to any practical width. Generally, a width of from 1 to 10 millimeters is the widest practical width. However, wider patterns can be formed depending on the application. In one aspect of the present invention, line widths can be from about 0.01 μm to about 10 μm. Those skilled in the art will recognize, upon review of the present disclosure that line widths can be affected by the materials used for the photo-degradable polymer template and the porosity of specific substrates.

Similarly, the metallic elements can have varying depths as measured from the substrate to an upper surface of the printed metallic element. The depth of the conductive material can be easily controlled by altering the thickness of the metal applied to the photo-degradable polymer template. Additionally, the depth can be increased or otherwise altered by repeating the application process, or by carrying out subsequent steps such as removal steps, melting steps, and/or sintering steps. The depth of the printed metallic elements can range from about 0.01 μm to about 10 μm, although depths of from about 0.01 μm to about 1.0 μm are sufficient for most applications, including for use as circuitry in electronic devices.

Photo-Degradable Polymers

As mentioned briefly above, with respect to the photo-degradable polymer that can be used, any photo-degradable polymer that is functional for a given application is within the scope of the present invention. For example, the photo-degradable polymer can be UV-degradable, IR-degradable, or visible light-degradable. Appropriate polymers (or monomers use to prepare such polymers) that can be used include copolymers of a vinyl ketones with polyethylene, polypropylene or polyethylene; ethylene/carbon monoxide/vinyl acetate ternary copolymers; copolymers of ethylene, styrene, and carbon monoxide; diazo-containing copolymers; metal-metal bond containing copolymers; and mixtures thereof.

Formula 1 below depicts an example of a diazo containing polymer, which when exposed to ultraviolet light, decomposes to form small molecules that are solvent soluble. Thus, the residual molecules that are formed can be easily removed after printing by a simple solvent extraction or washing.

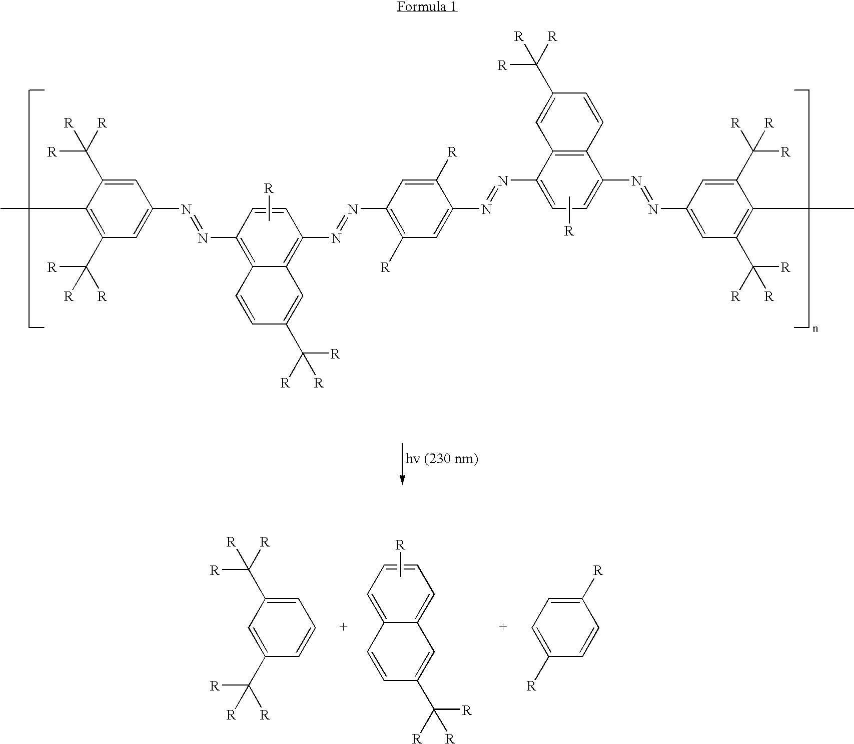

In Formula 1 above, each R can independently be hydrogen, hydrocarbon (either saturated or unsaturated), substituted hydrocarbon, carboxylic acid or its derivatives, sulfuric acid or its derivatives, phosphoric acid and its derivatives, nitro, nitrile, amine, hetero atoms (e.g., N, O, S, P, F, B, Si, I, Cl, Br), or functional group with at least one of above-mentioned hetero atoms (e.g., OH, SH, NH, COOH, CN, etc.), etc.

Formulas 2 and 3 below are exemplary of a photo-degradable star-shaped polymers and photo-degradable triangle-shaped polymers, respectively, which can also be used in accordance with embodiments of the present invention. 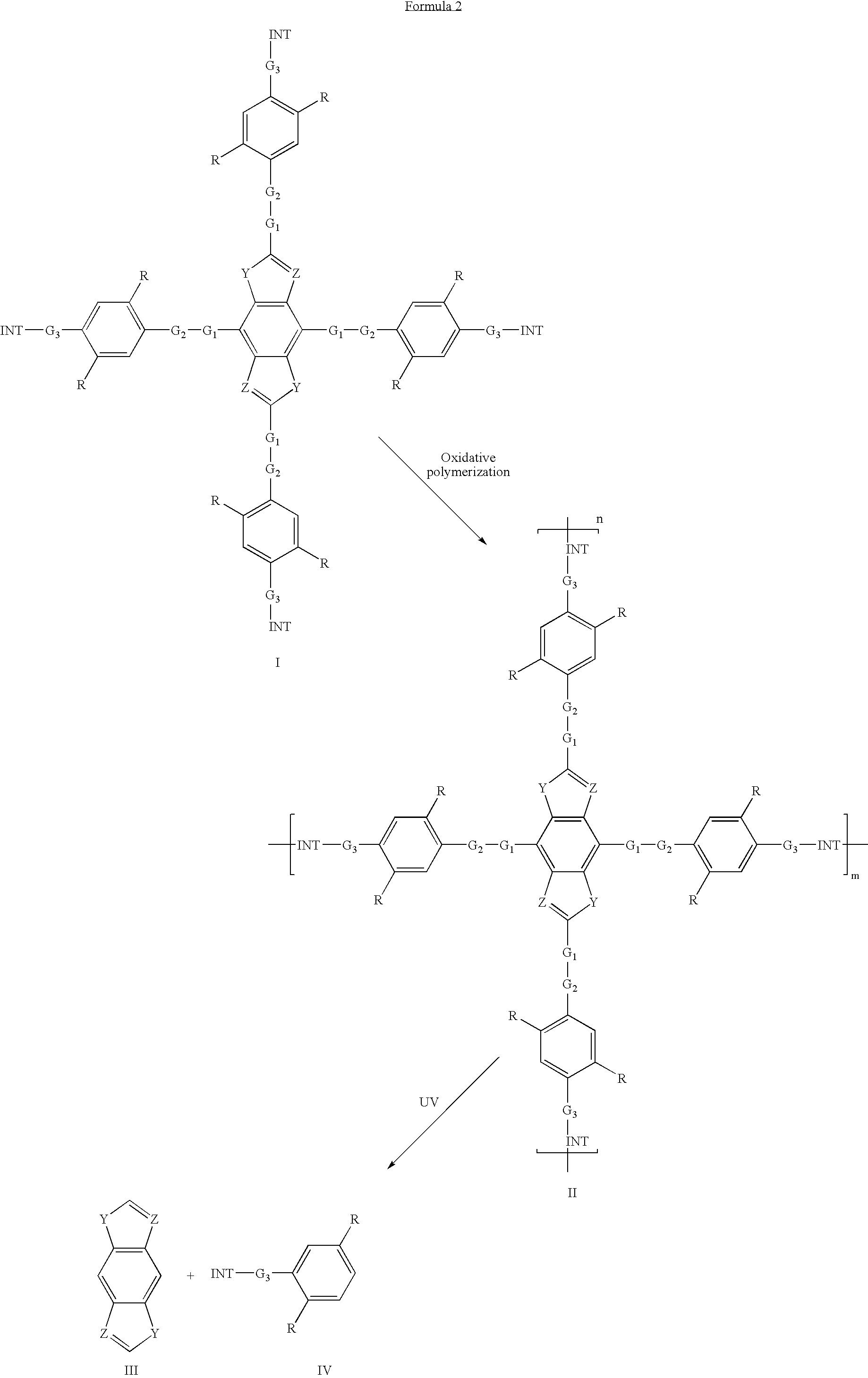 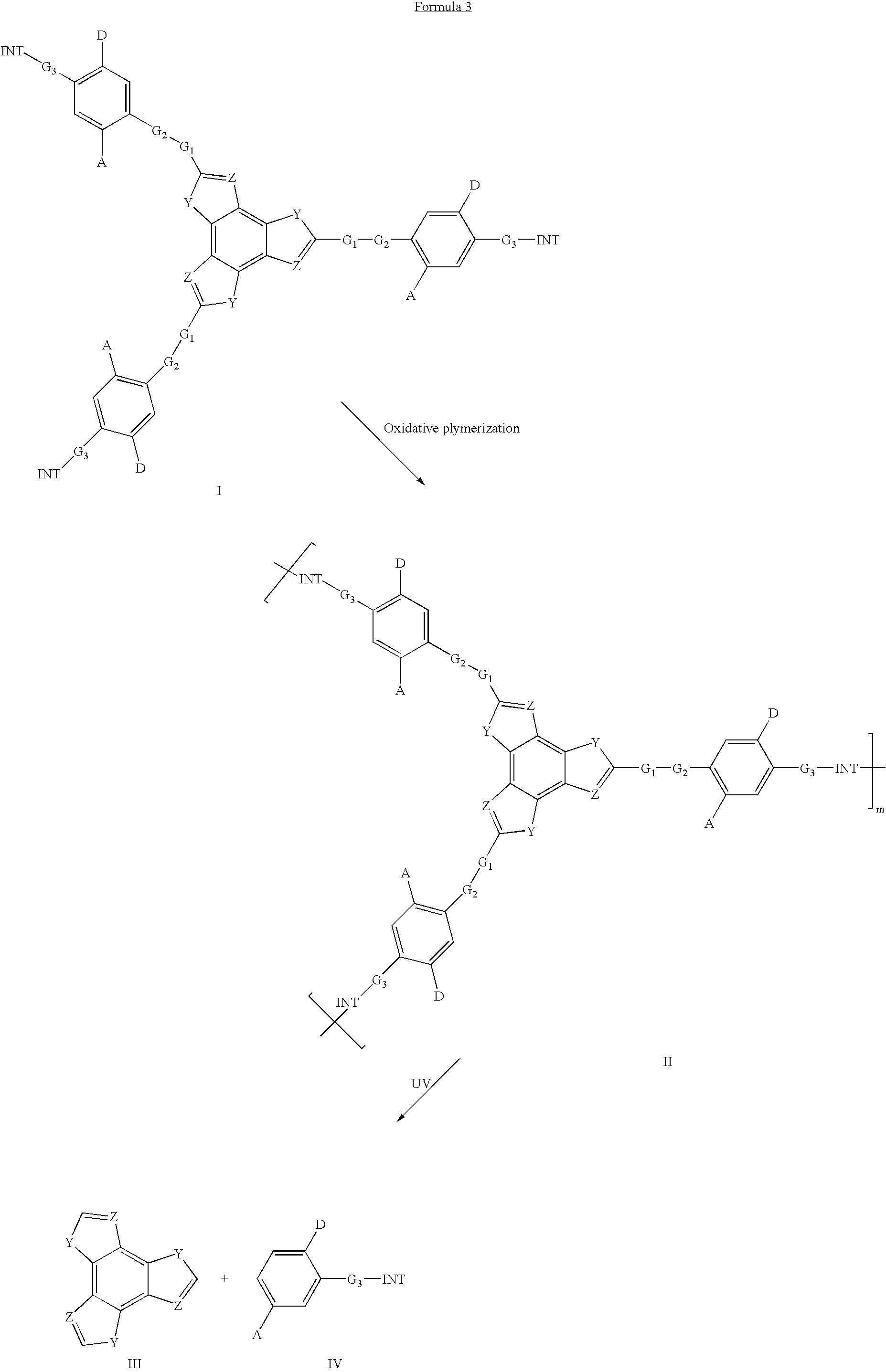
In Formulas 2 and 3 above, Y and Z can be atoms or atomic subunits that can be used to form five-member ring systems. Both X and Y can represent the same or different atom or subunit, which can be, but is not limited to, one of following: N, S, O, P, NH, N-alkyl, hydrocarbon (e.g., —CH₂—, etc), or substituted hydrocarbon. Each R can independently be hydrogen, hydrocarbon (either saturated or unsaturated), substituted hydrocarbon, carboxylic acid or its derivatives, sulfuric acid or its derivatives, phosphoric acid and its derivatives, nitro, nitrile, amine, hetero atoms (e.g., N, O, S, P, F, B, Si, I, Cl, Br), or functional group with at least one of above-mentioned hetero atoms (e.g., OH, SH, NH, COOH, CN, etc.), etc. G₁, G₂, G₃, G₄, G₅, and G₆ can independently represent a conjugated connecting unit such as, but not limited to, one of the following: acetylene or substituted acetylene, ethane or substituted ethane, >C═N—, —N═N—, etc. INT represents a functional hydrocarbon, which can initialize electrochemical or oxidation polymerization upon application of a current or oxidation reagent, respectively. These groups can be any of, but not limited to, thiophenes, substituted thiophenes, anilines, substituted anilines, pyrroles, substituted pyrroles, furans and substituted furans, as will be described in more detail in Formula 4 below. Oxidation reagents that can be applied for oxidative polymerization include, but not limited to, any high oxidation state metal salts such as, Iron (III) salts, Cu (II) salts, Au (III) salts, Ru(VI) salts, Os (VIII) salts, Bi(V) salts, Sb(V) salts.

In further detail with respect to Formulas 2 and 3 above, monomer (I) is a very useful building block for construction of a highly conjugated cross-structured 2-D photo-degradable polymer systems. More specifically, oxidative polymerization of monomer (I) via either oxidation reagents or electrochemical polymerization leads to the formation of highly conjugated 2-D polymeric networks (II). The 2-D polymeric materials from both formulas have high molecular weights and very strong mechanical strength. When each polymer is exposed to ultraviolet energy, it decomposes to form solvent soluble small molecules (III) and (IV), respectively, and consequently, the molecular system can be removed easily after printing by a simple solvent extraction or washing.

Preferred initiating entities which can be used in accordance with embodiments of the present invention include, but are not limit to, 3,4-dialkylthiophenes, 3,4-cycloalkylthiophenes, 3,4-dialkyloxythiophenes, 3,4-alkylenedioxythiophenes, 3,4-dialkylpyrroles, 3,4-cycloalkylpyrroles, 3,4-dialkyloxypyrroles, 3,4-alkylenedioxypyrroles, 2,3,5,6-tetraalkylanilines, 2,3,5,6-biscycloalkylanilines, 2,3,5,6-tetraalkyloxyanilines, 2,3,5,6-bisalkylenedioxyanilines. Formula 4 below sets forth examples of INT groups that can undergo oxidative polymerization in accordance with embodiments of the present invention. 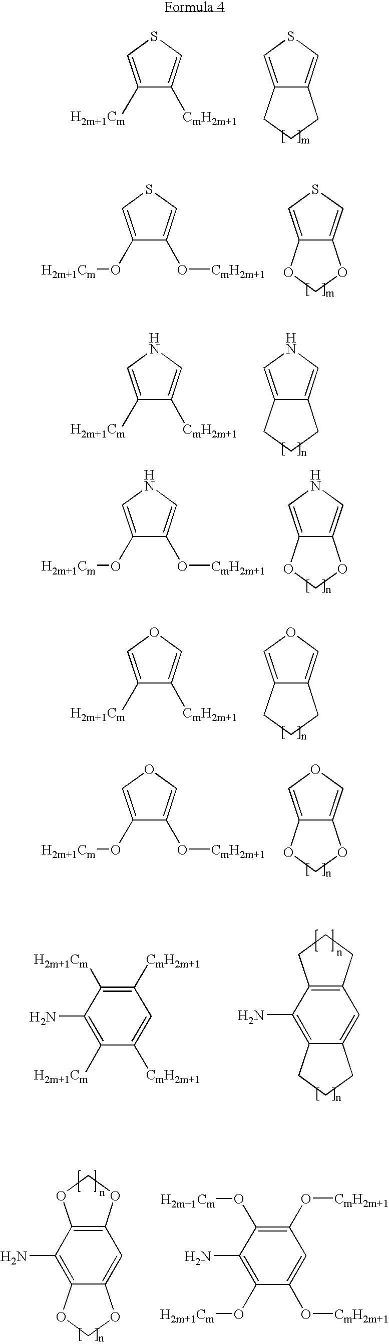
In Formula 4 above, m represents any whole numbers from 1 to 8, and n can be 1 or 2.

The following example illustrates an exemplary embodiment of the invention. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following example provides further detail in connection with what is presently deemed to be practical embodiments of the invention.

### EXAMPLE

On the surface of a patterned master pattern template of polydimethylsiloxane (PDMS) is spin-coated a film of 2 μm photo-degradable polymer (copolymer of styrene and vinyl acetate and dried under vacuum). The photo-degradable polymer is lifted from the master pattern template by binding a solid polymer sheet to an outer surface of the photo-degradable polymer template by rolling the sheet on the surface of the template. Next, on the surface of the polymer, a film of gold is formed by chemical vapor deposition (CVD). A portion of the film of gold is then adhered to a substrate. Specifically, on the surface of a silicon wafer substrate, a thin layer (ca 10 nm) of epoxy resin was spin-coated on top of the silicone wafer, which acts to adhere the film of gold to the epoxy resin coated silicon wafer. Ultraviolet light is exposed to the photo-degradable polymer and the photo-degradable polymer decomposes to form small molecules which are easily removable by washing with a solvent, leaving patterned gold on the silicone wafer surface.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

What is claimed is:

1. A method of printing metallic elements, comprising:
(a) forming a photo-degradable polymer template comprising a photo-degradable polymer;
(b) depositing a metal layer on the photo-degradable polymer template;
(c) adhering at least a portion of the metal layer to a substrate;
(d) exposing the photo-degradable polymer template to photo energy to cause the photo-degradable polymer to degrade; and
(e) leaving at least a portion of the metal layer adhered to the substrate to form printed metallic elements.

2. A method as in claim 1, wherein the step of forming the photo-degradable polymer template includes forming the polymer on a master pattern template, and removing the photo-degradable polymer template from the master pattern template.

3. A method as in claim 1, wherein the photo-degradable polymer is prepared using photo-degradable monomers in a solvent solution, and substantially removing solvent from the solution.

4. A method as in claim 1, wherein the photo-degradable polymer template includes peaks and troughs.

5. A method as in claim 4, wherein the step of depositing the metal layer includes forming metal-coated peaks on the peaks and metal-coated troughs on the troughs.

6. A method as in claim 1, wherein the step of depositing the metal layer is by sputtering.

7. A method as in claim 1, wherein the step of depositing the metal layer is by chemical vapor deposition (CVD).

8. A method as in claim 1, wherein the metal layer is a metal oxide or hydroxide, an elemental metal, a metal alloy, or a metal salt.

9. A method as in claim 5, wherein the step of adhering includes adhering at least a portion of the metal-coated peaks to the substrate, and wherein at least a portion of the metal-coated troughs are not adhered to the substrate.

10. A method as in claim 1, wherein the substrate includes an adhesive layer.

11. A method as in claim 10, wherein the step of adhering is by chemically bonding the metal layer to the adhesive layer.

12. A method as in claim 10, wherein the step of adhering is by physically bonding the metal layer to the adhesive layer.

13. A method as in claim 1, wherein the step of adhering is by directly bonding of the metal layer to the substrate without the presence of an intervening adhesive layer.

14. A method as in claim 1, wherein the step of exposing the photo-degradable polymer template to photo energy causes the photo-degradable polymer to substantially fully degrade.

15. A method as in claim 1, wherein the step of leaving at least a portion of the metal layer adhered to the substrate to form printed metallic elements is carried out by separating portions of the metal layer that are not adhered to the substrate from portions of the metal layer that are adhered to the substrate.

16. A method as in claim 1, wherein the photo-degradable polymer is UV-degradable.

17. A method as in claim 1, wherein the photo-degradable polymer is IR-degradable.

18. A method as in claim 1, wherein the photo-degradable polymer is visible light-degradable.

19. A substrate printed with metallic elements, comprising:
(a) substrate;
(b) metallic elements printed on the substrate, said metallic elements printed by the steps of:
(i) forming a photo-degradable polymer template comprising a photo-degradable polymer;
(ii) depositing a metal layer on the photo-degradable polymer template;
(iii) adhering at least a portion of the metal layer to the substrate;
(iv) exposing the photo-degradable polymer template to photo energy to cause the photo-degradable polymer to degrade; and
(v) leaving at least a portion of the metal layer adhered to the substrate to form printed metallic elements.

20. A substrate printed with metallic elements as in claim 19, wherein the metal layer is selected from the group consisting of gold, silver, copper, platinum, aluminum, zinc, cadmium, cobalt, nickel, palladium, iridium, iron, and lead.

21. A substrate printed with metallic elements as in claim 19, wherein the metal layer is elemental gold.

22. A substrate printed with metallic elements as in claim 19, wherein the photo-degradable polymer is a spin-coated polymer.

23. A substrate printed with metallic elements as in claim 19, wherein the photo-degradable polymer is selected from the group consisting of vinyl ketones with polyethylene, polypropylene or polyethylene; ethylene/carbon monoxide/vinyl acetate ternary copolymers; copolymers of ethylene, styrene, and carbon monoxide; diazo-containing copolymers; metal-metal bond containing copolymers; star-shaped polymers; triangle-shaped polymers, and mixtures thereof.

24. A substrate printed with metallic elements as in claim 19, wherein the substrate is selected from the group consisting of silicon substrates, polyethylene terephthalates, polyimides, epoxy resins, phenolic resins, polyester resins, aluminum nitride, and alumina ceramics.

25. A substrate printed with metallic elements as in claim 19, wherein the substrate includes an adhesive layer.

26. A substrate printed with metallic elements as in claim 19, wherein the metallic elements provide electronic circuitry.
